(19) United States
(12) Patent Application Publication
(10) Pub. No.: US 2009/0176541 A1
(43) Pub. Date: Jul. 9, 2009

(54) MOBILE WIRELESS TERMINAL DEVICE

(76) Inventor: Yusuke Okajima, Chiba (JP)

Correspondence Address: BIRCH STEWART KOLASCH & BIRCH, PO BOX 747, FALLS CHURCH, VA, 22040-0747, US

(21) Appl. No.: 12/304,959

(22) PCT Filed: Jun. 27, 2007
(86) PCT No.: PCT/JP2007/062911

§ 371 Date: Dec. 15, 2008

(51) Int. Cl. H04M 1/00

(52) U.S. Cl. 455/575.3

(57) ABSTRACT

In a mobile wireless terminal device comprising a first housing that contains a first substrate; an antenna that is disposed in an upper edge portion of the first housing; and a second housing that is disposed in the upper edge portion of the first housing in an openable/closeable manner through a hinge portion, and that contains a second substrate, characterized in that the first substrate and the second substrate are connected by a cable including a GND and a signal line, and current distribution control means having a frequency characteristic with a predetermined impedance is disposed at an arbitrary position on the cable, the cable and a GND on the substrate are connected at an optimum position in each frequency band, and thereby it is possible to obtain excellent antenna characteristics in all frequency bands in use, regardless of a position of a cable connector.

### FIELD OF THE INVENTION

The present invention relates to a mobile wireless terminal device that corresponds to a plurality of frequency bands as a wireless communication system.

### DESCRIPTION OF THE RELATED ART

Recently, mobile telephone devices have been required to have high antenna characteristics under the limited space and terminal conditions, as a space for disposing components is reduced due to miniaturization and the number of components is increased due to multifunction. In many folding-type mobile telephone devices, a connecting position of a cable for connecting between two housings is provided near the center portion of the housing, because a large-sized component such as a camera is disposed in a hinge portion.

However, when the connecting position is at the center portion of the housing, a current flowing through a substrate and a current flowing through the cable are in opposite phase at a place where the cable and the substrate inside the housing are overlapped, resulting that the antenna characteristics are deteriorated and the optimum connecting condition is not realized in terms of the antenna characteristics. In order to solve the above-mentioned problem, an invention as described in the Patent Document 1 has been known.

The invention described in the Patent Document 1 will be described with reference to the drawing. As shown in FIG. 19, a folding-type mobile telephone device has two housings 1 and 2 that are coupled in an openable/closable manner in a coupling portion 3. In addition, signal lines in substrates 4 and 5 inside the two housings 1 and 2 are electrically connected by a cable 6 through connector portions 7 and 8 that are provided near the center portion of the substrate 4 and in the lower edge portion of the substrate 5, respectively. The housing 1 has an antenna portion 9 in the upper edge portion of the coupling portion 3 side, and the antenna portion 9 is connected to a wireless circuit portion in the substrate 4. The cable 6 has GND exposed portions 10 that are electrically connected to the GND in the edge portion of the coupling portion 3 in the substrate 4. The above-mentioned configuration causes currents to flow through the substrate 4 and the cable 6 from the GND exposed portions, resulting that the currents in opposite phase do not flow through the substrate and the cable, and the antenna characteristics are improved. In addition, the structure in the Patent Document 1 enables to obtain high antenna characteristics, regardless of the connector position in the housing for the cable connection.

### Patent Document 1: Japanese Laid-Open Patent Publication No. 2006-5567

### SUMMARY OF THE INVENTION

### Problems to be Solved by the Invention

However, recent mobile telephone devices increasingly use not only one frequency band but a plurality of frequency bands. The mobile telephone devices are required to correspond to many frequency bands, for example, by being provided with other wireless functions such as a digital television, a wireless LAN, and Bluetooth (registered trademark). In addition, in wireless communication systems of them, used frequency bands are often separated each other, and in such a case, the current distribution in the housing varies substantially for every frequency.

Then, in the invention described in the above-mentioned Patent Document 1, the cable and the GND of the substrate are connected at an optimum position only in a desired frequency band, and thereby the antenna characteristics are improved. Accordingly, when a plurality of frequency bands are used, each frequency has an optimum position where the cable and the GND of the substrate are connected, and it has been impossible to improve the antenna characteristics in all frequency bands by the connection at only one position as the conventional technique.

The present invention has been made in view of the above-mentioned problems, and it is an object of the invention to provide a mobile wireless terminal device in which a cable and a GND of a substrate are connected at an optimum position in each frequency band so that excellent antenna characteristics are obtained in all frequency bands in use, regardless of the connector position of the cable.

### Means to Solve the Problems

In view of the above mentioned problems, the present invention has an object to improve the antenna characteristics in a desired frequency band without deteriorating the characteristics in all frequency bands in use, in a mobile wireless terminal device that corresponds to a plurality of frequency bands.

To realize the above object, in a mobile communication terminal device according to the present invention, a mobile wireless terminal device that corresponds to a plurality of frequency bands as a wireless communication system comprises: a first housing that contains a first substrate; an antenna that is disposed in an upper edge portion of the first housing; and a second housing that is disposed in an openable/closable manner through a hinge portion in the upper edge portion of the first housing, and that contains a second substrate, and is characterized in that the first substrate and the second substrate are connected by a cable including a GND and a signal line, and one or more current distribution control means having a given impedance of a frequency characteristic are disposed at an arbitrary position on the cable.

Further, it is characterized in that the current distribution control means includes a conductive connection portion that is electrically connected to the cable, and the conductive connection portion is connected to a GND in the first or second housing through a reactance element.

In this configuration, each of the current distribution control means makes a desired frequency band to be connected to the GND have a low impedance characteristic, and other frequency bands have a high impedance characteristic, at a desired position regardless of a connector position, and thereby the GND connection is almost made only in the specified frequency band in the current distribution control means, and the connection is not made in other frequency bands in the current distribution control means. Therefore, the GND connection is made at an optimum position in any frequency bands so that excellent antenna characteristics are obtained.

Further, it is characterized in that the current distribution control means includes a conducting portion that is disposed in the cable through an insulating material in a non-contact manner, and the conducting portion is composed of a contact conductor that is connected to the GND on the first or second substrate.

In this configuration, it is possible to easily connect the GND in the cable and the GND on the substrate with a frequency characteristic.

Further, it is characterized in that the current distribution control means includes the conducting portion that is disposed in the cable through the insulating material in the non-contact manner, and the conducting portion is connected to the GND in the first or second housing through the reactance element.

In this configuration, it is further possible to perform a strict frequency control of an impedance even in a limited range.

Further, it is characterized in that the current distribution control means includes a switch portion that is connected to the conductive connection portion; and a plurality of reactance elements that are disposed between the switch portion and the GND in the first or second housing.

Further, it is characterized in that the current distribution control means includes the switch portion that is connected to the conducting portion; and the plurality of reactance elements that are disposed between the switch portion and the GND in the first or second housing. In this configuration, at the same position on the cable, the connection of the reactance element having a different frequency characteristic is switched by the switch, and thereby it is possible to switch the connection of the GND on the substrate and the GND in the cable in accordance with a situation.

Further it is characterized in that the current distribution control means includes the switch portion between the reactance elements and the GDN in the first or second housing, and the switch portion switches a connection or a disconnection of the reactance elements to the GND in the first or second housing.

Further, it is characterized in that the current distribution control means includes the conducting portion that is disposed in the cable through the insulating material in the non-contact manner; and the switch portion that switches a connection or a disconnection of the conducting portion to the GND in the first or second housing.

In this structure, it is possible to switch the connection or the disconnection of the cable and the GND on the substrate at a desired position in accordance with situation.

Further, it is characterized in that the mobile wireless terminal device further includes housing state detection means for detecting such as an opened/closed state of the housings, and causes the switch portion to operate by a detection signal from the housing state detection means. In this configuration, it is possible to select an optimum method for connecting the cable and the GND on the substrate in accordance with a state of the terminal, resulting that more excellent antenna characteristics are obtained in all states.

Further, it is characterized in that the mobile wireless terminal device further includes used state determination means at the time of a telephone conversation, a data communication, or a stand-by, etc., and causes the switch portion to operate by the used state determination means.

In this configuration, it is possible to select an optimum method for connecting the cable and the GND on the substrate by the used state in the terminal, and more excellent antenna characteristics are obtained for every used state.

Further, it is characterized in that the mobile wireless terminal device further includes another antenna that is additionally provided; and antenna detection means for detecting a used state of the antenna and the another antenna, and causes the switch portion to operate by a detection signal from the antenna detection means.

In this configuration, it is possible to select an optimum method for connecting the cable and the GND on the substrate by a used antenna, and excellent antenna characteristics are obtained even when the another antenna is used.

Further, it is characterized in that the mobile wireless terminal device further includes communication system determination means for determining a used frequency, and the current distribution control means includes the conductive connection portion that is electrically connected to the cable; and the switch portion that switches a connection or a disconnection of the conductive connection portion to the GND in the first or second housing, and causes the switch portion to operate by the used frequency.

In this configuration, it is possible to connect the cable and the GND on the substrate at 0Ω, the current in opposite phase flowing through the cable is more reduced than the above-mentioned low-impedance connection, resulting that excellent antenna characteristics are obtained.

### EFFECT OF THE INVENTION

According to the mobile wireless device of the present invention, in a mobile telephone device that corresponds to a plurality of frequency bands as a wireless function, high antenna characteristics are obtained in all frequency bands regardless of a connecting position of the cable for connecting the two substrates.

### BRIEF DESCRIPTION OF THE DRAWINGS

FIG. 1 is a view showing a component configuration of a folding-type mobile communication terminal of a first embodiment;

FIG. 2 is an enlarged view of a connecting location of a thin wire coaxial cable and a first substrate in the first embodiment;

FIG. 3 is a view showing a frequency characteristic of a transmission characteristic of a reactance element in the first embodiment;

FIG. 4(A) is a view showing antenna characteristics in each connecting location and an antenna characteristic in the first embodiment;

FIG. 4(B) is a view showing antenna characteristics in each connecting location and an antenna characteristic in the first embodiment;

FIG. 5 is a view showing a component configuration of a folding-type mobile communication terminal of a second embodiment;

FIG. 6 is a view showing a frequency characteristic of a transmission characteristic of a metal-wrapped portion in the second embodiment;

FIG. 7 is a view showing a component configuration of a folding-type mobile communication terminal of a third embodiment;

FIG. 8 is a view showing frequency characteristics of transmission characteristics of metal-wrapped portions in the third embodiment;

FIG. 9 is a view showing a component configuration of a folding-type mobile communication terminal of a fourth embodiment;

FIG. 10(A) is a view showing a switch state at the time of opening and closing in the fourth embodiment;

FIG. 10(B) is a view showing a switch state at the time of opening and closing in the fourth embodiment;

FIG. 11 is a view showing a component configuration of a folding-type mobile communication terminal of a fifth embodiment;

FIG. 12 is a view showing frequency characteristics of transmission characteristics of reactance elements in the fifth embodiment;

FIG. 13(A) is a view showing a switch state by a used antenna in the fifth embodiment;

FIG. 13(B) is a view showing a switch state by a used antenna in the fifth embodiment;

FIG. 14 is a view showing a component configuration of a folding-type mobile communication terminal of a sixth embodiment;

FIG. 15 is a view showing a frequency characteristic of a transmission characteristic of a reactance element in the sixth embodiment;

FIG. 16 is a view showing a component configuration of a folding-type mobile communication terminal of a seventh embodiment;

FIG. 17(A) is a view showing a switch state by a used frequency in the seventh embodiment;

FIG. 17(B) is a view showing a switch state by a used frequency in the seventh embodiment;

FIG. 18 is a view showing a component configuration of a folding-type mobile communication terminal in a modified example; and

FIG. 19 is a view showing a component configuration of a folding-type mobile communication terminal of a conventional example.

### EXPLANATIONS OF NUMERALS

1 first housing
2 second housing
3 coupling portion
4 first substrate
5 second substrate
6 thin wire coaxial cable
7 first connector portion
8 second connector portion
9 first antenna portion
92 second antenna portion
93 antenna portion for Bluetooth
10 GND exposed portion
11 contact pattern
12, 121, 122, and 123 reactance elements
13, 131, and 132 metal-wrapped portions
14 opening/closing detection means
151, 152, and 153 switch portions
16 used antenna detection means
17 used frequency detection means

### DESCRIPTION OF PREFERRED EMBODIMENTS

Now, referring to the drawings, preferred embodiments of the present invention will be described. In the embodiments, an example in which a mobile wireless terminal device is applied to a mobile telephone device that corresponds to the 800 MHz band and the 2 GHz band, will be described.

### The First Embodiment

First, the first embodiment will be described with reference to the drawings. FIG. 1 is a schematic configuration view of a mobile telephone device in the present embodiment. The mobile telephone device is a folding-type mobile telephone device that has a first housing 1 and a second housing 2, which are connected by a coupling portion 3 for coupling in an openable/closable manner. Each of the first housing 1 and the second housing 2 has a first substrate 4 and a second substrate 5, and the first substrate 4 and the second substrate 5 are electrically connected at each of connector portions 7 and 8 by a thin wire coaxial cable 6.

The connector portion 7 is provided near the center portion of the first substrate 4, and the connector portion 8 is provided in the lower edge of the second substrate 5. The thin wire coaxial cable 6 is a coaxial cable group including a GND and a signal line, which are covered with an insulating material, except for the connector portions. The first housing 1 has an antenna portion 9 that corresponds to the 800 MHz band and the 2 GHz band in the edge of the coupling portion 3, and the antenna portion 9 is connected to a wireless circuit portion in the first substrate 4, and is supplied with electric power from the left in the figure (opposite side of the thin wire coaxial cable).

The thin wire coaxial cable 6 has a GND exposed portion 10 in the edge portion of the first substrate 4. The first substrate 4 has a contact pattern 11 that is not connected to the GND, in the edge portion of the substrate, where the first substrate 4 is substantially overlapped with the thin wire coaxial cable 6.

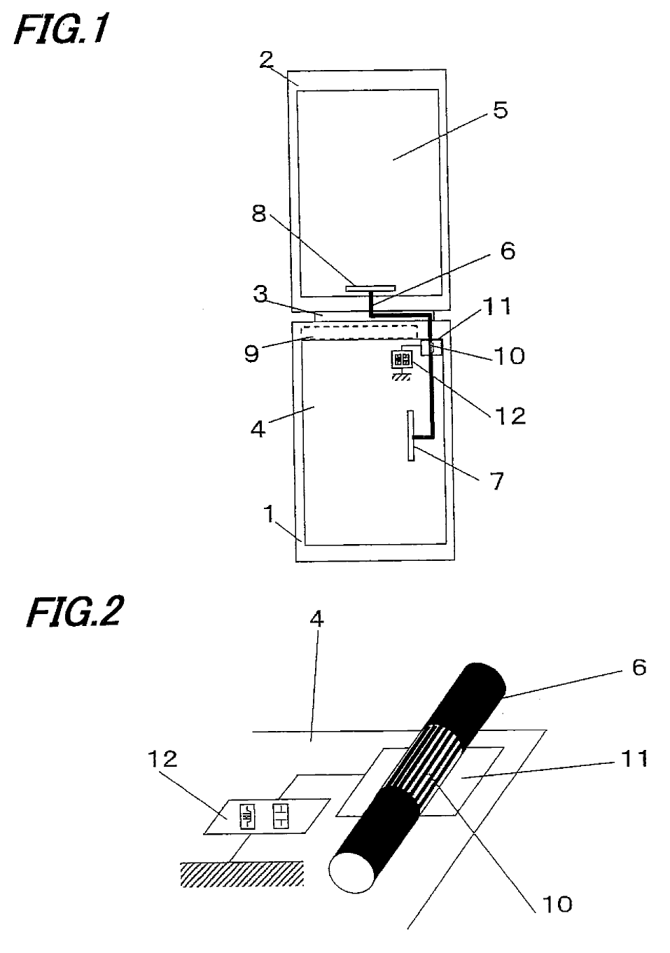

Further, FIG. 2 shows the GND exposed portion 10 in detail. As shown in FIG. 2, the GND exposed portion 10 in the thin wire coaxial cable 6 is directly and electrically connected to the contact pattern 11, and the contact patter 11 is connected to the GND of the first substrate 4 through a reactance element 12.

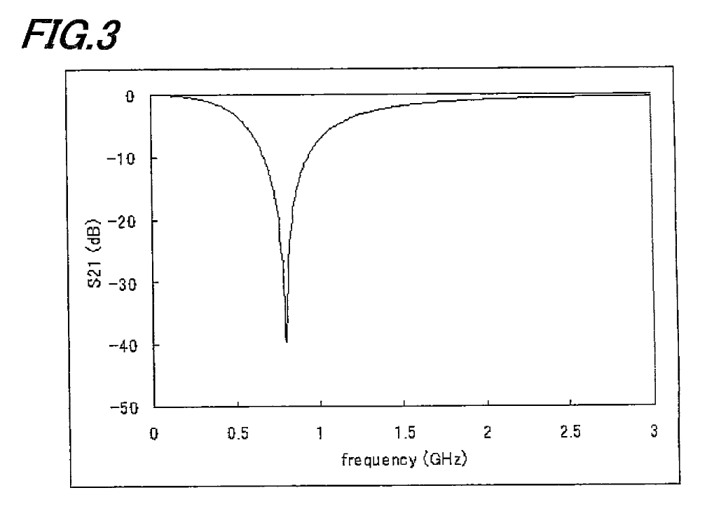

Here, a frequency characteristic of the reactance element 12 is shown in FIG. 3. FIG. 3 is a graph with the frequency as an abscissa, and with S21 (transmission characteristic) as an ordinate. According to FIG. 3, the reactance element 12 is an element that has a high impedance characteristic in the 800 MHz band, and has a low impedance characteristic in the 2 GHz band.

Furthermore, according to the configuration in the present embodiment, the GND in the thin wire coaxial cable 6 is almost electrically connected to the GND of the first substrate, from the edge portion of the first substrate 4 in the 2 GHz band, and from the first connector portion 7 that is disposed in the center portion of the first substrate 4.

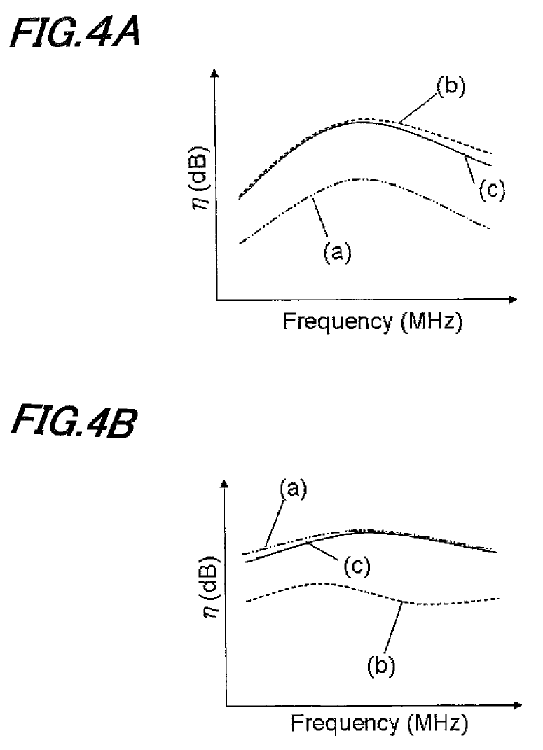

FIGS. 4(A) and 4(B) show antenna characteristics, in a case where the GND in the thin wire coaxial cable is connected at the edge portion of the substrate, in a case where the GND in the thin wire coaxial cable is connected at the center portion of the substrate, and in a case of the configuration of the present embodiment. FIG. 4(A) shows a graph of the antenna characteristics in the 800 MHz band, and FIG. 4(B) shows a graph of the antenna characteristics in the 2 GHz band. FIGS. 4(A) and 4(B) are graphs with the frequency as an abscissa, and with the antenna efficiency η as an ordinate. Here, in both graphs of FIGS. 4(A) and 4(B), (a) denotes the antenna characteristic when the cable is connected at the edge of the substrate, (b) denotes the antenna characteristic when the cable is connected at the center of the substrate, and (c) denotes the antenna characteristic when the cable is connected in the present embodiment.

As shown in FIG. 4(A), in the 800 MHz band, when being connected in the contact pattern 11 in the edge portion of the substrate, a connection length between the first housing 1 and the second housing 2 is short, from the edge portion of the first substrate 4 to the second connector portion 8, thus the second housing 2 seems to be the GND. As a result, the GND volume near the antenna portion 9 increases, and the antenna characteristic is deteriorated as shown in (a) of FIG. 4(A) In the connection at the center portion of the substrate, as shown in (b) of FIG. 4(A), the connection length is also long, from the first connector portion 7 to the second connector portion 8, and the second housing 2 does not seem to be the GND, resulting that the antenna characteristic is hardly deteriorated. In addition, also in the 800 MHz band as described below, although the current in opposite phase to the substrate flows through the thin wire coaxial cable, its length is an ignorable length with respect to the frequency, and the antenna characteristic is not deteriorated.

As shown in FIG. 4(B), in the 2 GHz band, when being connected at the center portion of the substrate, the current in opposite phase to the substrate flows through the thin wire coaxial cable, and its length can not be ignored for the 2 GHz band, resulting that the antenna characteristic is deteriorated as shown in (b) of FIG. 4(B). In the connection at the edge of the substrate, the current in opposite phase does not flow through the thin wire coaxial cable, thus the antenna characteristic is improved as shown in (a) of FIG. 4(B). In addition, as described above, the connection length between the first housing 1 and the second housing 2 is short, however, the length is sufficient for the 2 GHz band and the second housing 2 does not seem to be the GND, thus the antenna characteristic is hardly deteriorated.

In this way, in the present embodiment, the GND in the thin wire coaxial cable and the GND of the first substrate 3 are almost connected from the connector portion 7 in the center portion of the substrate in the 800 MHz band, and from the edge portion of the substrate in the 2 GHz band, and therefore the connections are made at optimum positions in the 800 MHz band and the 2 GHz band. Accordingly, high antenna characteristics can be obtained in both bands as shown in (c) of FIG. 4.

### The Second Embodiment

Subsequently, the second embodiment will be described with reference to the drawings. First, FIG. 5 is a schematic configuration view of a mobile telephone device in the second embodiment. As shown in FIG. 5, in the second embodiment, the thin wire coaxial cable 6 has a metal-wrapped portion 13 through an insulating material. The metal-wrapped portion 13 is electrically connected to the GND of the first substrate 4 in the edge portion of the first substrate 4. Note that, if any part in other component configuration is same as in the first embodiment, same reference numeral is given thereto, with repeated description omitted.

According to the configuration shown in FIG. 5, the GND in the thin wire coaxial cable and the metal metal-wrapped portion 13 are not electrically connected because of being through the insulating material, but connected in a high frequency manner by a capacitive coupling.

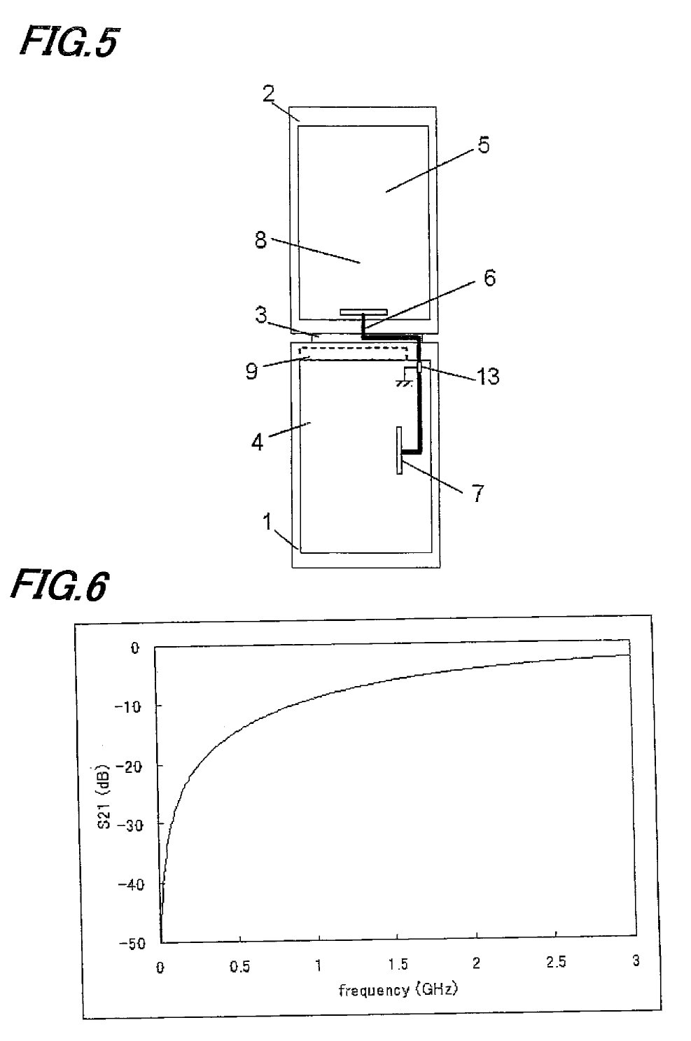

Therefore, as shown in FIG. 6, the GND in the thin wire coaxial cable and the GND of the first substrate 4 are connected in the edge portion of the substrate, in the frequency characteristic of the high impedance under the 800 MHz band, and in the frequency characteristic of the low impedance under the 2 GHz band, by the capacitive coupling of the GND in the thin wire coaxial cable and the metal-wrapped portion 13. FIG. 6 is a graph with the frequency as an abscissa, and with S21 (transmission characteristic) as an ordinate According to this configuration, the connection is made almost electrically to the GND of the first substrate from the edge portion of the first substrate 4 in the 2 GHz band, and from the first connector portion 7 in the 800 MHz band, resulting that, similar to the first embodiment, high antenna characteristics can be obtained in both bands. In addition, it is not necessary that the thin wire coaxial cable 6 is provided with the GND exposed portion in the present embodiment, thus making manufacturing easier.

### The Third Embodiment

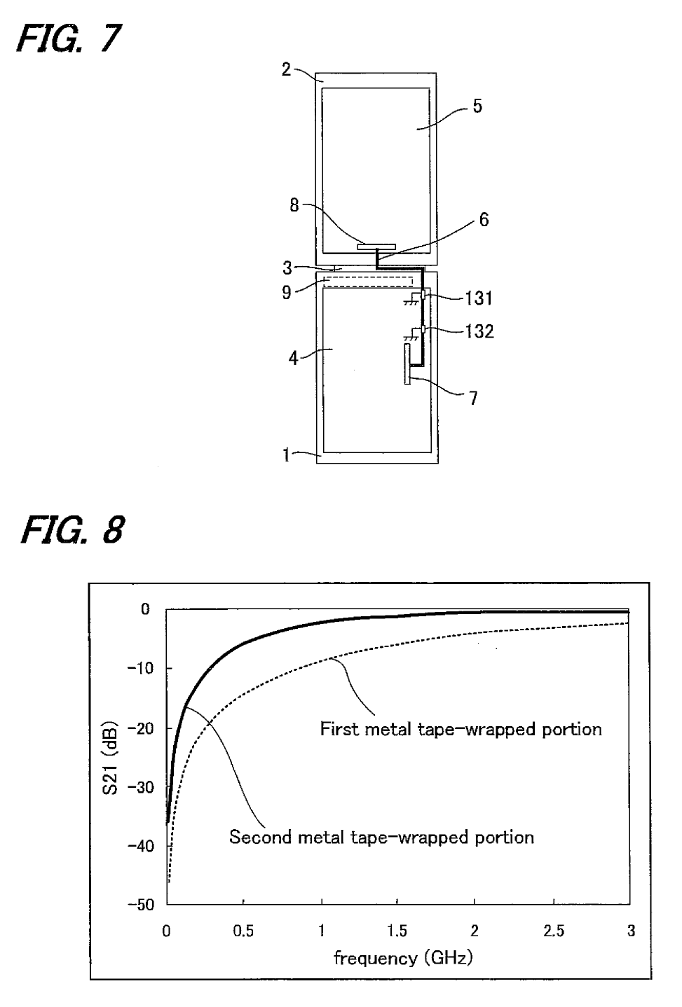

Subsequently, the third embodiment will be described with reference to the drawings. FIG. 7 is a schematic configurational view of a mobile telephone device in the third embodiment. Note that, if any part in other component configuration is same as in the first embodiment, same reference numeral is given thereto, with repeated description omitted.

The thin wire coaxial cable 6 has a first metal-wrapped portion 131 and a second metal-wrapped portion 132 that have different wrapping areas through the insulating material.

Regarding to the wrapping areas of the two metal-wrapped portions 131 and 132, the area of the metal-wrapped portion 131 is small, and the area of the metal-wrapped portion 132 is large. With this structure, the capacitive couplings are different in each of the metal-wrapped portions, and therefore the frequency characteristics of the impedance in each of the metal-wrapped portions are also different. The frequency characteristics in each of the metal-wrapped portions at this time are shown in FIG. 8. FIG. 8 is a graph with the frequency as an abscissa, and with S21 (transmission characteristic) as an ordinate. The metal-wrapped portion 131 has the frequency characteristic of the high impedance in the 800 MHz band, and has the frequency characteristic of the low impedance in the 2 GHz band. The metal-wrapped portion 132 has the frequency characteristic of the low impedance also in the 800 MHz band.

Here, the first metal-wrapped portion 131 is provided in the edge portion of the first substrate 4, and is connected to the GND at the edge portion of the first substrate 4. The second metal-wrapped portion 132 is provided between the first metal-wrapped portion 13 and the first connector, and is connected to the GND of the first substrate 4 at a location being substantially overlapped with the first substrate 4.

According to the configuration shown in FIG. 7, the GND in the thin wire coaxial cable 6 is almost electrically connected from the first metal-wrapped portion 131 (the edge portion of the first substrate 4) in the 2 GHz band, and from the second metal-wrapped portion 132 in the 800 MHz band. Accordingly, excellent antenna characteristics can be obtained, similar to the first and second embodiments.

Note that, in the 800 MHz band, it is possible to optimize the connecting position of the GND of the substrate and the GND in the cable, regardless of the connector position; therefore, the connection length between the first housing 1 and the second housing 2 is sufficiently kept and the current in opposite phase flowing through the thin wire coaxial cable is decreased, resulting that the antenna characteristics are further improved.

### The Fourth Embodiment

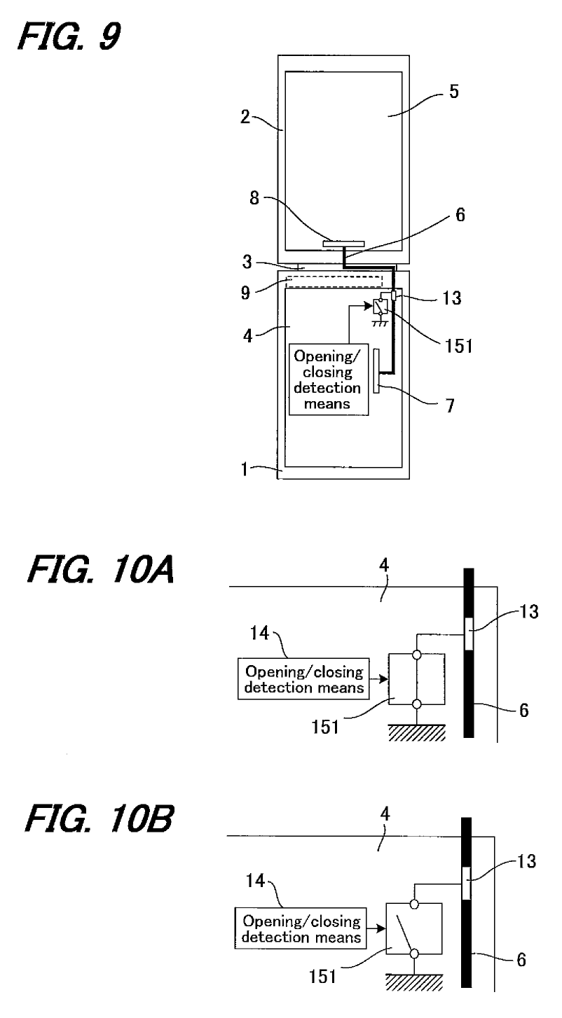

Subsequently, the fourth embodiment will be described with reference to the drawings. FIG. 9 is a schematic configuration view of a mobile telephone device in the fourth embodiment. Note that, if any part in other component configuration is same as in the first embodiment, same reference numeral is given thereto, with repeated description omitted.

First, the mobile telephone device shown in FIG. 9 has opening/closing detection means 14. In addition, the thin wire coaxial cable 6 has the metal-wrapped portion 13 through the insulating material. In addition, a switch portion 151 that switches a connection by the opening/closing detection means 14 is provided. The metal-wrapped portion 13 is connected to the GND of the first substrate 4 through the switch portion 151.

The opening/closing detection means 14 is a means to detect an opened/closed state of the mobile telephone in the present embodiment, and detects whether the first housing 1 and the second housing 2 are in the opened state or in the closed state. Then, the switch portion 151 is controlled in response to the opened/closed state.

FIGS. 10(A) and 10(B) show states of the opening/closing detection means 14 and the switch portion 151 in detail. FIG. 10(A) shows a state where the mobile telephone device (the first housing 1 and the second housing 2) is detected to be in the opened state, in which the switch portion 151 is operated so as to be connected to the GND when the switch portion 151 is closed. On the other hand, FIG. 10(B) shows a state where the mobile telephone device (the first housing 1 and the second housing 2) is detected to be in the closed state, in which the operation is made so as to be disconnected to the GND. Note that, other component configurations are same as that of the first embodiment, thus the description thereof will be omitted.

According to the configuration in the embodiment, in a case where the first housing 1 and the second housing 2 are in the opened state, the GND in the thin wire coaxial cable 6 is almost electrically connected to the GND of the first substrate from the edge portion of the first substrate 4 in the 2 GHz band, and from the first connector portion 7 in the 800 MHz band, thus excellent antenna characteristics can be obtained in both frequency bands.

On the other hand, in a case where the first housing 1 and the second housing 2 are in the closed state, antenna current distribution flowing through the first substrate 4 and the second substrate 5 is changed from the opened state, and when connected to the thin wire coaxial cable 6 at the edge portion of the first substrate 4, the currents in opposite phase flowing through the first substrate 4 and the second substrate 5 are increased, in particular, in the 2 GHz band, compared with the connection at the first connector portion 7 in the center portion of the first substrate 4, resulting that the antenna characteristics are deteriorated. Accordingly, in the embodiment, when the first housing 1 and the second housing 2 are in the closed state, the connecting point in the first substrate 4 is moved from the edge portion of the first substrate 4 to the first connector portion 7.

As a result, compared with the connection at the edge portion of the first substrate 4, the current phase on the second substrate is delayed, the currents in opposite phase are decreased, and the antenna characteristics are not deteriorated, thus excellent antenna characteristics can be obtained even when the mobile telephone device is in the closed state.

### The Fifth Embodiment

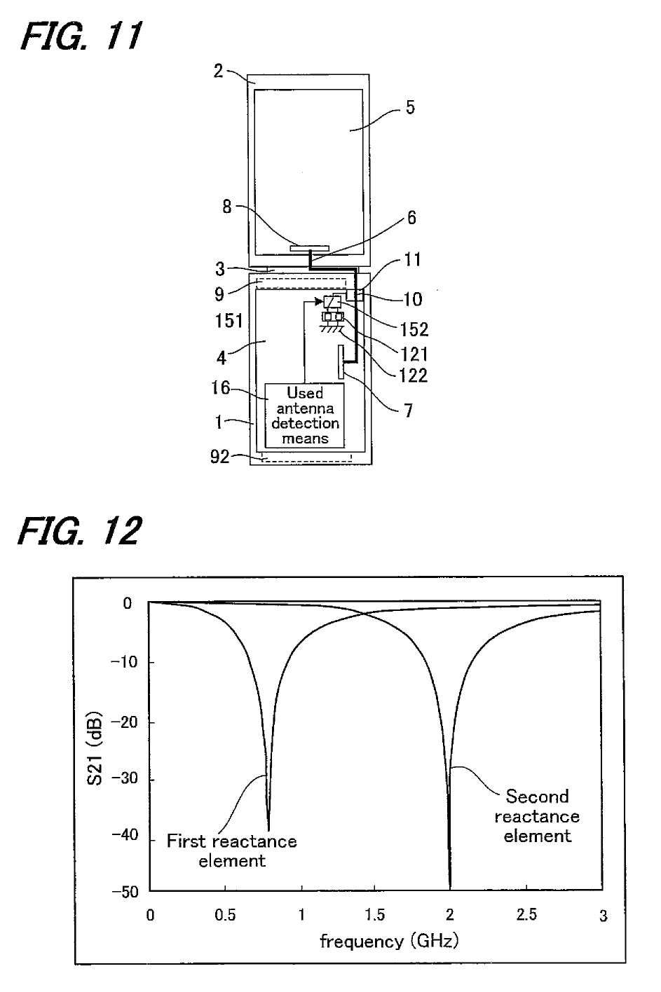

Subsequently, the fifth embodiment will be described with reference to the drawings. FIG. 11 is a schematic configuration view of a mobile telephone device in the fifth embodiment. Note that, if any part in other component configuration is same as in the first embodiment, same reference numeral is given thereto, with repeated description omitted.

First, the mobile telephone device shown in FIG. 11 has a second antenna portion 92 in the lower edge portion of the first housing 1. The second antenna 92 is connected to the wireless circuit portion in the first substrate 4.

The mobile telephone device further has used antenna detection means 16, and a first reactance element 121 and a second reactance element 122 having different frequency characteristics in the first housing. For example, the frequency characteristics of the first reactance element 121 and the second reactance element 122 are shown in FIG. 12. The first reactance element 121 has the high impedance characteristic in the 800 MHz band and has the low impedance characteristic in the 2 GHz band, and the second reactance element 122 has the low impedance characteristic in the 800 MHz band and has the high impedance characteristic in the 2 GHz band. A switch portion 152 that switches a connection between the first reactance element 121 and the second reactance element 122 is provided.

Further, the thin wire coaxial cable 6 has the GND exposed portion 10. The first substrate 4 has the contact pattern 11 that is not connected to the GND, in the edge portion of the substrate, where the substrate is substantially overlapped with the thin wire coaxial cable 6. The contact pattern 11 is connected to the GND of the first substrate 4 through the first reactance element 121 when the first antenna is used, and through the second reactance element 122 when the second antenna 92 is used, by the switch of the switch portion 152.

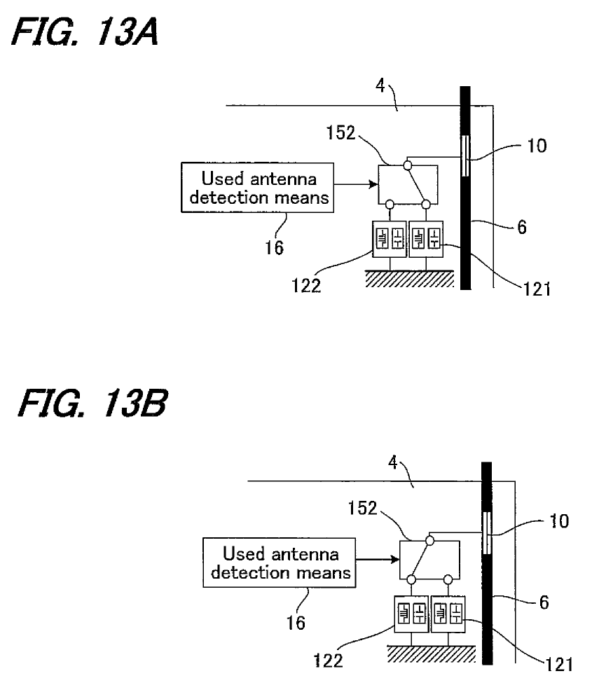

Here, FIG. 13(A) shows a state where the used antenna detection means 16 detects that the first antenna 9 is used. When the first antenna 9 is used, the switch portion 152 is switched to connect to the GND of the first substrate 4 through the first reactance element 121.

Further, FIG. 13(B) shows a state where the used antenna detection means 16 detects that the second antenna 92 is used. When the second antenna 92 is used, the switch portion 152 is switched to connect to the GND of the first substrate through the second reactance element 122.

According to this configuration, when the first antenna 9 is used, similar to the above-mentioned first embodiment, the GND of the first substrate 4 and the GND in the thin wire coaxial cable are connected at the edge of the substrate in the 2 GHz band, and at the first connector portion in the 800 MHz band, thus excellent antenna characteristics can be obtained in both frequency bands.

On the other hand, when the second antenna 92 is used, the GND of the first substrate 4 and the GND in the thin wire coaxial cable are connected at the first connector portion in the 2 GHz band, and at the edge of the substrate in the 800 MHz band.

In this way, when the second antenna 92 is used, the current distribution is different from the case that the first antenna 9 is used, and the thin wire coaxial cable 6 and the first substrate 4 are connected at the first connector portion 7 in the 2 GHz band, and thereby the same phase of currents flow through the thin wire coaxial cable 6 and the first substrate 4, thus the antenna characteristics are enhanced.

Further, in the 800 MHz band, the first substrate 4 and the second substrate 5 are connected so as to have the shortest length therebetween, and thereby almost optimum housing length is realized and excellent antenna characteristics are obtained.

### The Sixth Embodiment

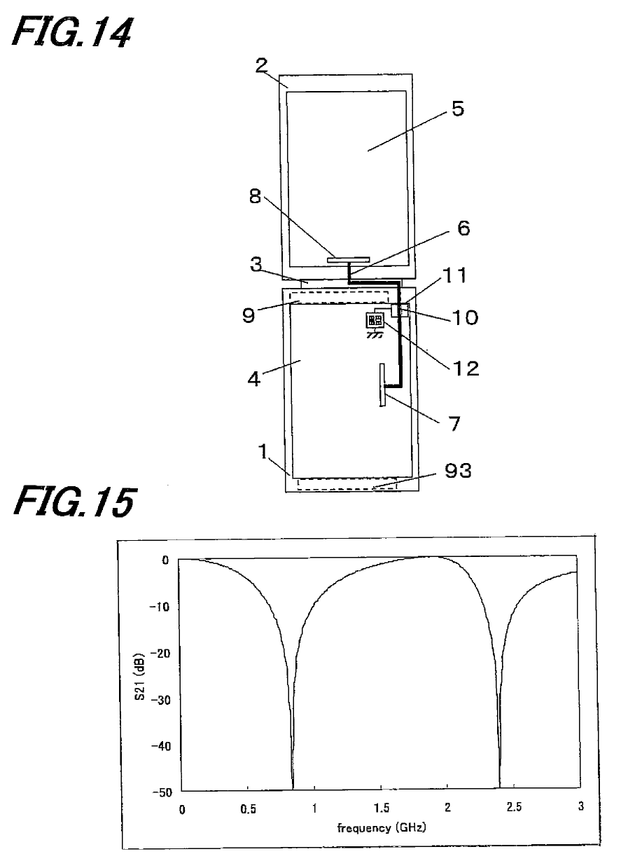

Subsequently, the sixth embodiment will be described with reference to the drawings. FIG. 14 is a schematic configurational view of a mobile telephone device in the sixth embodiment. Note that, if any part in other component configuration is same as in the first embodiment, same reference numeral is given thereto, with repeated description omitted.

The mobile telephone device shown in FIG. 13 has an antenna for Bluetooth 93 in the 2.4 GHz band in the lower edge portion inside the first housing 1. Here, the antenna 93 is connected to the wireless circuit portion in the first substrate 4.

Further, the thin wire coaxial cable 6 has the GND exposed portion 10. The first substrate 4 has the contact pattern 11 that is not connected to the GND, in the edge portion of the substrate, where the substrate is substantially overlapped with the thin wire coaxial cable 6. The contact pattern 11 is connected to the GND of the first substrate 4 through the reactance element 123.

Here, the frequency characteristic of the reactance element 123 is shown in FIG. 15. FIG. 15 is a graph with the frequency as an abscissa, and with the transmission characteristic (S21) as an ordinate. The reactance element 123 has the high impedance characteristic in the 800 MHz and 2.4 GHz bands, and has the low impedance characteristic in the 2 GHz band.

According to this configuration, when the antenna 9 for the mobile telephone device is used, similar to the above-mentioned first embodiment, the GND of the first substrate 4 and the GND in the thin wire coaxial cable are connected at the edge of the substrate in the 2 GHz band, and at the first connector portion in the 800 MHz band, thus excellent antenna characteristics can be obtained in both frequency bands.

On the other hand, when the antenna for Bluetooth 93 that is disposed in the lower edge portion inside the first housing 1 is used, the current distribution is different from the case that the first antenna 9 for the mobile telephone device is used, and the GND in the thin wire coaxial cable 6 and GND of the first substrate 4 are connected at the first connector portion 7, and thereby the same phase of currents flow through the thin wire coaxial cable 6 and the first substrate 4, thus the characteristics of the antenna for Bluetooth are enhanced.

### The Seventh Embodiment

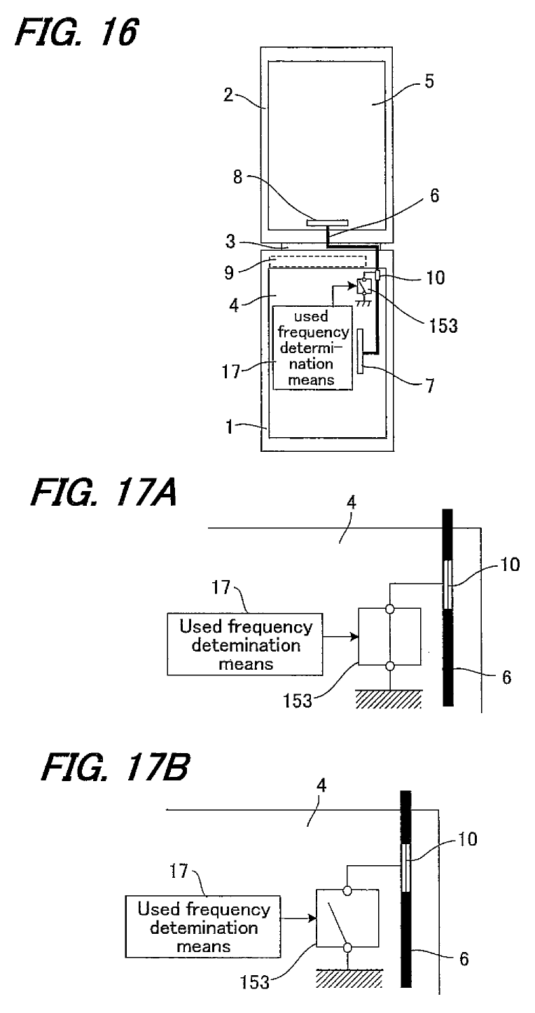

Subsequently, the seventh embodiment will be described with reference to the drawings. FIG. 16 is a schematic configuration view of a mobile telephone device in the seventh embodiment. Note that, if any part in other component configuration is same as in the first embodiment, same reference numeral is given thereto, with repeated description omitted.

The mobile telephone device shown in FIG. 16 has used frequency determination means 17. Further, the mobile telephone device has a switch portion 153 that switches a connection by the used frequency determination means 17, and the thin wire coaxial cable 6 has the GND exposed portion 10.

The GND exposed portion 10 is connected to the GND of the first substrate 4 at the edge portion of the first substrate 4 through the switch portion 153. The switch portion 153 is operated so as to be disconnected when the 800 MHz band is used, and to be connected when the 2 GHz band is used, by the used frequency determination means 17. Specifically, when the used frequency determination means 17 determines that the used frequency is the 2 GHz band, the switch portion 153 is turned into the closed state as shown in FIG. 17(A). In addition, when the used frequency is determined to be the 800 MHz band, the switch portion 153 is turned into the opened state as shown in FIG. 17(B).

According to the configuration shown in FIG. 16, the impedance of the connection between the GND of the first substrate 4 and the GND in the thin wire coaxial cable 6 is 0Ω. Compared with the case that the GND of the first substrate 4 and the GND in the thin wire coaxial cable 6 are connected at the high impedance, when the connection is of 0Ω, the current in opposite phase does not flow through the thin wire coaxial cable 6 more easily in the 2 GHz band, thus more excellent antenna characteristics can be obtained than the first and second embodiments in the high impedance connection.

### The Modified Example

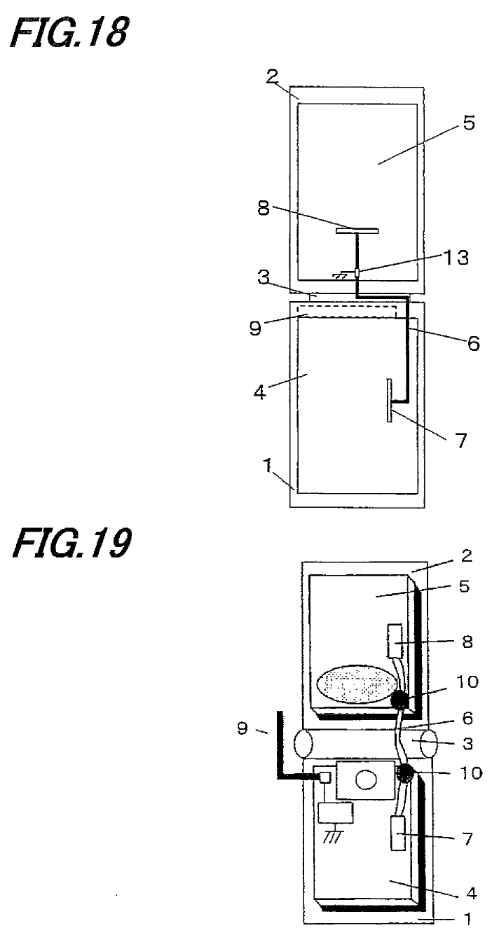

Note that, although each embodiment is an example in which the GND in the thin wire coaxial cable 6 and the GND of the first substrate 4 are connected in the first housing 1, the GND in the thin wire coaxial cable 6 and the GND of the second substrate 5 may be connected in the second housing 2 through a current distribution controlling apparatus such as the reactance element and the metal-wrapped portion, which have been describe in the embodiments. As an example, a state when connected through the metal-wrapped portion is shown in FIG. 18.

Further, in each embodiment, although the GND in the thin wire coaxial cable 6 and the GND of the first substrate 4 are connected at the edge portion of the first substrate 4, it is not necessary that the connection is made at the edge portion of the substrate because optimum connecting position varies depending on the used frequency.

Further, in each embodiment, although the thin wire coaxial cable 6 is connected to the GND of the substrate, without limitation to the GND of the substrate, the connection may be performed by a GND of a peripheral device such as a metal folder, a camera, and a shield case.

Further, in each embodiment, although the mobile telephone device that corresponds to the 800 MHz and 2 GHz bands has been described, without limitation to the 800 MHz and 2 GHz bands, other frequencies such as 1.7 GHz band, and other wireless communication systems such as a wireless LAN, a GPS, and a digital television, are applicable.

Further, the mobile telephone device in each embodiment may be provided with components such as a display portion, an operation portion, a camera, and a speaker, which are mounted on a mobile telephone device.

1. A mobile wireless terminal device that corresponds to a plurality of frequency bands as a wireless communication system, comprising:
a first housing that contains a first substrate;
an antenna that is disposed in an upper edge portion of the first housing; and
a second housing that is disposed in the upper edge portion of the first housing in an openable/closeable manner through a hinge portion, and that contains a second substrate, characterized in that
the first substrate and the second substrate are connected by a cable including a GND and a signal line, and
one or more current distribution control means having a frequency characteristic a predetermined impedance are disposed at an arbitrary position on the cable.

2. The mobile wireless terminal device according to claim 1, wherein the current distribution control means comprises a conductive connection portion that is electrically connected to the cable, and the conductive connection portion is connected to a GND in the first or second housing through a reactance element.

3. The mobile wireless terminal device according to claim 1, wherein the current distribution control means comprises a conducting portion that is disposed in the cable through an insulating material in a non-contact manner, and the conducting portion is composed of a contact conductor that is connected to a GND on the first or second substrate.

4. The mobile wireless terminal device according to claim 1, wherein the current distribution control means comprises the conducting portion that is disposed in the cable through the insulating material in the non-contact manner, and the conducting portion is connected to the GND in the first or second housing through the reactance element.

5. The mobile wireless terminal device according to claim 2, wherein the current distribution control means comprises a switch portion that is connected to the conductive connection portion; and a plurality of reactance elements that are disposed between the switch portion and the GND in the first or second housing.

6. The mobile wireless terminal device according to claim 4, wherein the current distribution control means comprises the switch portion that is connected to the conducting portion; and the plurality of reactance elements that are disposed between the switch portion and the GND in the first or second housing.

7. The mobile wireless terminal device according to claim 2, wherein the current distribution control means comprises the switch portion between the reactance elements and the GND in the first or second housing, and the switch portion switches a connection or a disconnection of the reactance elements to the GND in the first or second housing.

8. The mobile wireless terminal device according to claim 3, wherein the current distribution control means comprises the conducting portion that is disposed in the cable through the insulating material in the non-contact manner; and the switch portion that switches a connection or a disconnection of the conducting portion to the GND in the first or second housing.

9. The mobile wireless terminal device according to claim 5, wherein the mobile wireless terminal further comprises housing state detection means for detecting such as an opened/closed state of the housings, and causes the switch portion to operate by a detection signal detected by the housing state detection means.

10. The mobile wireless terminal device according to claim 5, wherein the mobile wireless terminal further comprises used state determination means at the time of a telephone conversation, a data communication, or a stand-by, etc., and causes the switch portion to operate in response to a used state determined by the used state determination means.

11. The mobile wireless terminal device according to claim 5, wherein the mobile wireless terminal further comprises another antenna; and antenna detection means for detecting a used state of the antenna and the another antenna, and causes the switch portion to operate in response to the used state detected by the antenna detection means.

12. The mobile wireless terminal device according to claim 1, wherein the mobile wireless terminal further comprises communication system determination means for determining a used frequency, and the current distribution control means comprises the conductive connection portion that is electrically connected to the cable; and the switch portion that switches a connection or a disconnection of the conductive connection portion to the GND in the first or second housing, and causes the switch portion to operate in response to the used frequency determined by the communication system determination means.
